(19) United States
(12) Patent Application Publication
(10) Pub. No.: US 2011/0237169 A1
(43) Pub. Date: Sep. 29, 2011

(54) PEELER WITH CROWNED ROLLERS

(75) Inventor: Brent A. Ledet, River Ridge, LA (US)

(73) Assignee: LAITRAM, L.L.C., Harahan, LA (US)

(21) Appl. No.: 12/732,380

(22) Filed: Mar. 26, 2010

(51) Int. Cl. A22C 29/02

(52) U.S. Cl. 452/5

(57) ABSTRACT

Roller-type peeling apparatus and crowned rollers in the peeling channels of the peeling apparatus. Each peeling channel includes small-diameter insert rollers frictionally counterrotated by simultaneous contact with two large-diameter, rotating powered rollers separated across a gap. Holddowns at spaced locations along the length of the insert rollers hold the insert roller against the two powered rollers and into the mouth of the gap. The insert roller or the powered rollers are crowned between consecutive holddowns to compensate for the tendency of the insert roller to deflect and to provide uniform contact pressure between the insert roller and the powered rollers along the insert roller's length.

### BACKGROUND

This invention relates to peeling apparatus and more particularly to roller-type peeling machinery with crowned peeling rollers.

Originally introduced because of the high labor costs of peeling small shrimp by hand, shrimp peeling machines are now widely used in the shrimp processing industry. Roller-type shrimp-peeling machines, in particular, dominate the bulk shrimp peeling industry. U.S. Pat. Nos. 2,778,055, Jan. 22, 1957, and 2,537,355, Jan. 9, 1951, both to Fernand S., James M., and Emile M. Lapeyre, describe the basic structure and principles of operation of roller-type shrimp peelers.

U.S. Pat. No. 2,778,055 shows a peeling machine with a rigid framework supporting the peeling elements. A transverse beam divides the machine into two peeling sections. The upper peeling section extends from a rear wall to the beam; the lower peeling section extends from the beam to the lower front end of the machine. Shell-on shrimp are fed over the rear wall to the upper peeling section. Channels are formed in the upper peeling section by groups, or associations, of five rollers for each channel. The association of rollers includes a power roller forming the base of the channel, two laterally consecutive channel-forming rollers flanking and elevated slightly above the power roller, and two small-diameter insert rollers between the power roller and the channel-forming rollers. The power rollers extend the full length of the machine through both the upper and lower peeling sections. The power rollers are supported in the lower peeling section by base idler rollers, or lower rollers. All the rollers incline downwardly from the rear wall to the front end of the machine. The channel-forming rollers and the insert rollers extend only the length of the upper peeling section and are mounted at the rear wall and at the transverse beam. The power rollers and the channel-forming rollers are mounted in fixed locations so that their peripheries are separated across a narrow gap less than the diameter of the insert rollers. In this way, the insert rollers, which are not fixedly mounted at their ends as are the power and channel-forming rollers, can be forcibly urged by spring pressure into the mouths of the gaps between the power and channel-forming rollers. Holddowns at fixed positions along the length of the insert rollers use spring pressure to provide a tight nip, or pinch point, between the insert roller and the power roller. In the lower peeling section, two power rollers and a base idler roller, or lower roller, at a lower elevation form an inverted triangular lower peeling channel. The power rollers rotate the lower roller by frictional contact. The power rollers rotate in alternate directions to force shrimp in the upper peeling section into the nips on one side of the channel and then into the nips on the other side of the channel. The shrimp are unwrapped of their shells in the nips, the shells squeezed flat and pulled between the rotating power and insert rollers, falling as waste through the narrow gaps between the power roller and the channel-forming rollers. Most of the peeling is effected in the upper peeling section. Shells not removed in the upper peeling section are further subjected to pinching action between the large-diameter power rollers and the base idler roller in each channel of the lower peeling section.

As shown in FIG. 8, the insert rollers 10, which usually comprise a series of insert roller sections arranged end to end and held down into the nips by the holddowns 12 at the ends, tend to bow away from the power and channel-forming rollers 14, as indicated by an exaggerated separation 16. Even if there is no visible separation, the pressure exerted by the small-diameter insert rollers against the power and channel-forming rollers decreases with distance from the held down ends to a minimum pressure midway between the ends. This non-uniform pressure along the lengths of the insert rollers affects the pinching action on the shrimp and degrades the quality of the peeling.

### SUMMARY

The peeling problems caused by non-uniform insert-roller pressure are addressed by peeling apparatus having features of the invention. In one version, peeling apparatus comprises an insert roller in frictional contact with first and second rotating powered rollers separated by a gap extending along the length of the powered rollers. The insert roller, which has a smaller diameter than the first and second rollers, is held in counterrotating frictional contact with the rollers by forces applied at holddown positions along the length of the insert roller. The insert roller, the first roller, or the second roller is crowned with a maximum diameter between the holddown positions.

Another version of peeling apparatus comprises first and second rotating powered rollers separated by a gap extending along the length of the rollers. A smaller-diameter insert roller, which includes one or more insert roller sections, is disposed in the gap. Holddowns at the ends of the one or more insert roller sections extend through the gap to hold the insert roller in counterrotating frictional contact with the powered rollers. The insert roller, the first roller, or the second roller is crowned with a maximum diameter between the ends of the one or more insert roller sections.

Another version of peeling apparatus comprises an array of reciprocating lower rollers spaced apart laterally across the width of the peeling apparatus. Reciprocating channel-forming rollers flank the power rollers. The channel-forming rollers form a roller array that is elevated slightly above the array of lower rollers across narrow gaps between the lower rollers and the channel-forming rollers. Each lower roller forms the base of a peeling channel between laterally consecutive channel-forming rollers. A pair of insert rollers is disposed in each channel. Each insert roller contacts the lower roller and one of the channel-forming rollers along the gap. Holddowns apply a force at spaced apart locations along the length of the insert rollers. The force is directed toward the gap to hold the insert rollers in counterrotating frictional contact with the lower roller and the associated one of the channel-forming rollers. The insert rollers, the lower rollers, or the channel-forming rollers are crowned with a maximum diameter midway between the positions of the holddowns.

Another aspect of the invention provides an insert roller section held down in the peeling nip formed by a pair of closely spaced, larger-diameter rotating powered peeler rollers in the peeling section of a roller-type peeling apparatus. The insert roller section comprises a metal roller having a crowned outer surface with a single crown along its length.

In another aspect of the invention, a powered lower or channel-forming roller for frictionally counterrotating a smaller-diameter insert roller in the peeling section of a roller-type peeling apparatus comprises a roller having a crowned outer surface with at least one crown along its length.

### BRIEF DESCRIPTION OF THE DRAWINGS

These features and aspects of the invention, as well as its advantages, are described in more detail in the following description, appended claims, and accompanying drawings, in which:

FIG. 1 is an isometric view of peeling apparatus embodying features of the invention;

FIG. 2 is a cross section of one peeling channel in the upper peeling section of the peeling apparatus of FIG. 1 taken along lines 2-2;

FIG. 3 is a part schematic drawing, part perspective view of a peeling channel of the peeling apparatus of FIG. 1;

FIG. 4 is an exaggerated side view of a crowned insert roller usable in peeling apparatus as in FIG. 1;

FIG. 5 is an exaggerated isometric view of a hollow, crowned insert roller usable in peeling apparatuses in FIG. 1;

FIG. 6A is a side view of a crowned, knurled insert roller usable in peeling apparatuses in FIG. 1; and FIGS. 6B and 6C are enlarged views of the knurled surfaces of the knurled roller of FIG. 6A near an end and midway between the end;

FIG. 7 is an exaggerated side view of a multi-crowned peeling roller usable in peeling apparatus as in FIG. 1; and

FIG. 8 is an exaggerated side view of a bowed insert roller in peeling apparatus of the prior art.

### DETAILED DESCRIPTION

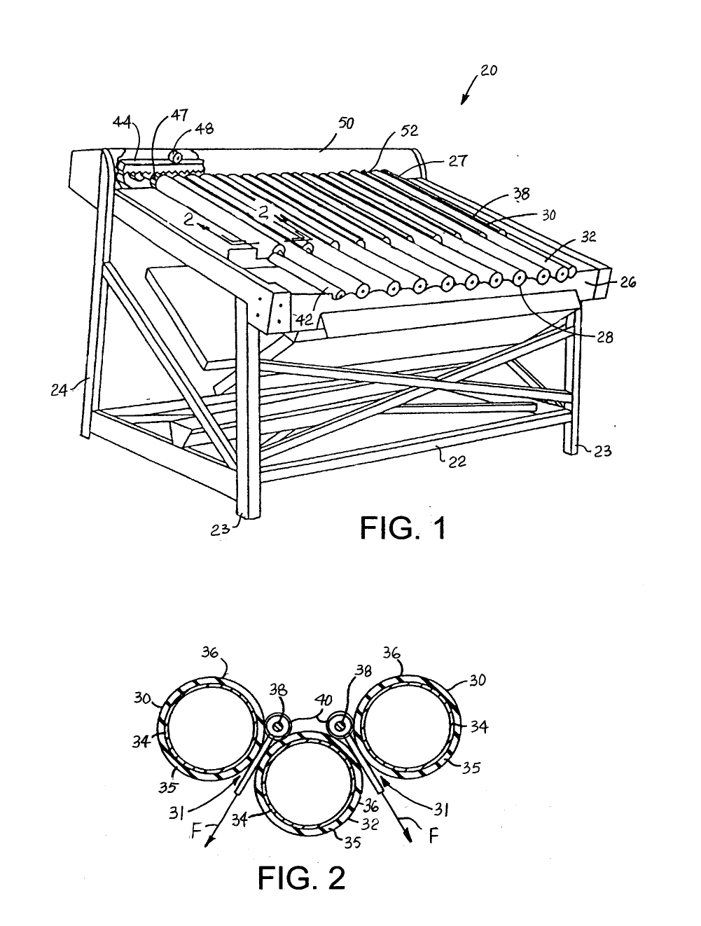

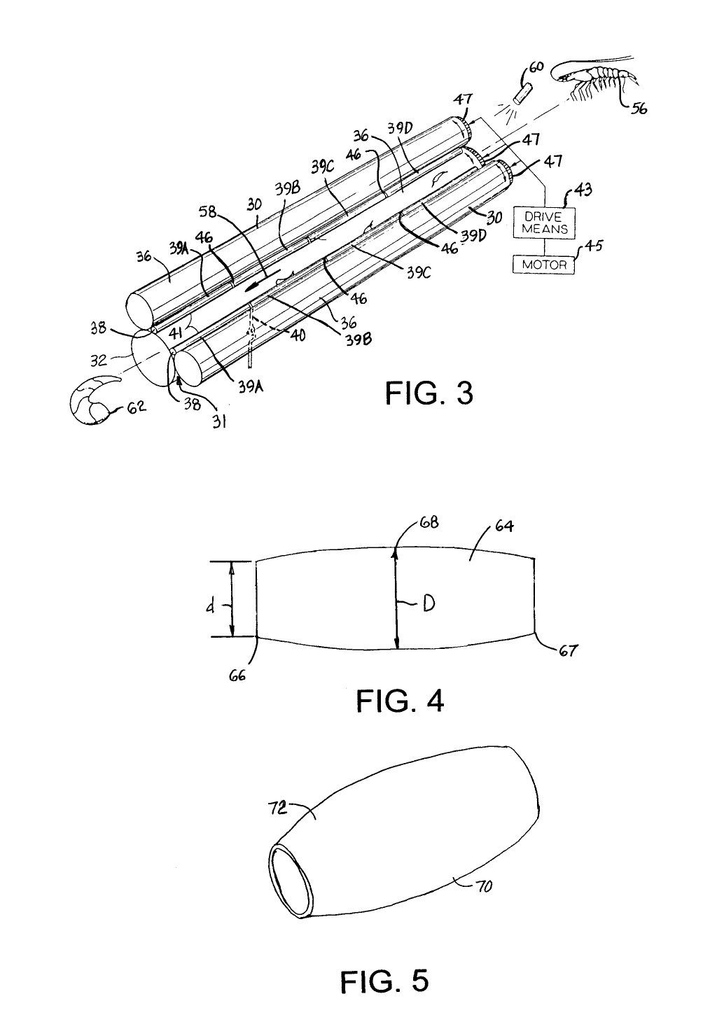

An exemplary version of a peeling apparatus embodying features of the invention is shown in FIG. 1. The peeling apparatus 20, which is typically used to peel shrimp, includes a frame 22 consisting of front and rear legs 23, 24 forming a framework with various cross-bracing and support members. A bed 26 supports peeling rollers that slope downward from a first product-entrance end 27 to a second product-exit end 28. (To simplify the drawing, a finger frame, typically used to urge shrimp into peeling positions, is not shown.) The rollers shown in FIG. 1 include two kinds of powered, reciprocating-roller arrays—an array of laterally spaced channel-forming rollers 30 and an array of laterally spaced lower rollers 32. In an upper peeling section of the peeling apparatus, a plurality of side-by-side peeling channels are formed by a roller arrangement shown in FIGS. 2 and 3. In the arrangement, a peeling channel is formed by a lower roller 32 forming the channel's base flanked by two channel-forming rollers 30 slightly elevated above the lower roller across a narrow gap 31. All three rollers are powered directly by the peeling apparatus's drive system. These powered, reciprocating rollers have nominal diameters of about 3 inches. Each of these powered rollers is made of a tube 34, typically steel, coated with a coating 35, such as a rubber-like material, to form an outer peeling surface 36. The coating could be a polyurethane material or another synthetic or natural material, to provide the peeling effectiveness or durability required by the application. The coating could be left off and the uncoated tube constructed entirely of stainless steel, for instance, with or without a knurled, sandblasted, or otherwise textured surface. The upper peeling channels are further formed by smaller-diameter insert rollers 38 held down into the mouths of the gaps 31 between the powered lower rollers and channel-forming rollers. The insert rollers rotate by frictional contact with the powered rollers, which are reciprocated alternately clockwise and counterclockwise by the drive system. The channel-forming rollers are rotated in the same direction as the power rollers to cause the insert rollers to counterrotate by frictional contact with the powered rollers. The insert rollers are typically made of stainless steel with or without surface texturing and have nominal diameters of about 0.5 inches. Each insert roller may be formed of a single insert roller section or of multiple insert roller sections 39A, 39B, 39C, 39D arranged end to end as in FIG. 3 with holddowns 40 biasing the insert rollers into the gaps 31 at spaced apart holddown positions 46 along the length of the insert roller, such as at the ends of each insert roller section. The insert rollers are encircled at various positions along the channel by the holddowns 40, shown in the form of straps. The straps, which extend through the narrow gaps 31 and are attached to the frame below, are tensioned by springs, for example, to hold the insert rollers down in the mouths of the gaps against the power and channel-forming rollers to form peeling nips 41 with the lower rollers. Peeling nips are also formed on the other side of the insert rollers between the insert rollers and the channel-forming rollers.

A lower peeling section of the peeling apparatus is formed by the powered lower rollers 32 supported on idler rollers 42. The channel-forming rollers 30 and the insert rollers 38 do not extend down into this lower peeling section of the apparatus. The peeling nips formed in the lower peeling section produce a peeling action different from that in the upper peeling section. Subjecting product to be peeled, such as shrimp, to both kinds of peeling actions produces a more effectively peeled product.

Both the powered channel-forming rollers 30 and the powered lower rollers 32 are powered at the upper end of the peeling apparatus. A drive system 43 comprising, for example, a rack gear 44 linked to a crank and a pitman arm driven by a motor 45 is used to reciprocate the rack gear. A drive member, including a toothed gear wheel 47, connected at a first end of each of the reciprocating rollers, meshes with the rack gear. As the rack gear reciprocates, the rollers continuously reverse directions of rotation between clockwise and counterclockwise in synchrony with the rack. Idler wheels 48, in rolling contact with the upper surface of the rack, retain it in position. A cover plate 50 at the first upper end of the rollers separates the drive system from the peeling channels. Openings 52 formed in the plate admit the drive member portion of the reciprocating powered rollers into an engagement position with the drive system of the peeling apparatus.

Unpeeled, uncooked shrimp 56 advance in the direction of the arrow 58 along the peeling channels from the entrance end to the exit end as the rollers rotate back and forth. A stream of water 60 helps advance the shrimp down the declining channels. Besides helping advance the shrimp along the channels, the back-and-forth rotation of the rollers shifts the shrimp alternately from one side of the channels to the other. Consequently, the shrimp are presented in constantly changing positions to the nips 41 between the lower roller and the insert rollers for fresh grips by the rollers to provide every opportunity for peeling. The peelings are squeezed and pulled by the counterrotating lower and insert rollers through the nips and drop through the gaps 31, while peeled shrimp meats 62 exit the channel at the lower exit end.

The force F (FIG. 2) applied to the insert rollers 38 by the holddowns 40 at the holddown positions 46 to hold the insert rollers in the gaps 31 tends to cause the insert rollers to bow, or bend, as previously described with reference to FIG. 8. The result of the tendency to bow is that the pressure applied by the insert roller in the nip against the lower and channel-forming rollers is not uniform along the insert roller's length, with the pressure at midlength less than at the held down ends. A conventional insert roller section having a circular cross section of constant diameter held down at its ends would tend to have a bent shape with a profile the same as the well-known deflection shape of a rod fixed at both ends and subjected to a uniform load along its length. To compensate for the tendency of an insert roller of constant cross section to bow and not provide uniform pressure along its length, an insert roller or inset roller section 64 having an outer periphery crowned with a profile to counteract the bending tendency caused by the holddowns at each end is used. The maximum diameter D of the insert roller section is about midway between its opposite ends 66, 67 at a crown 68 of the roller. (The rollers in FIG. 4 and those in FIGS. 5-7 are shown exaggerated to emphasize the more subtle and less visible crowning of the rollers.) For example, an insert roller section having a nominal diameter of 0.5 inches and a length of 13-22 inches might have a 10-40 thousandths inch crown and a minimum diameter d of 0.5 inches near the ends for a maximum diameter D of between 0.51 inches and 0.54 inches. (As used in this description, unless otherwise specified, the “nominal diameter” of a crowned roller means any diameter, such as the average, median, minimum, or maximum diameter, used to specify and compare rollers.)

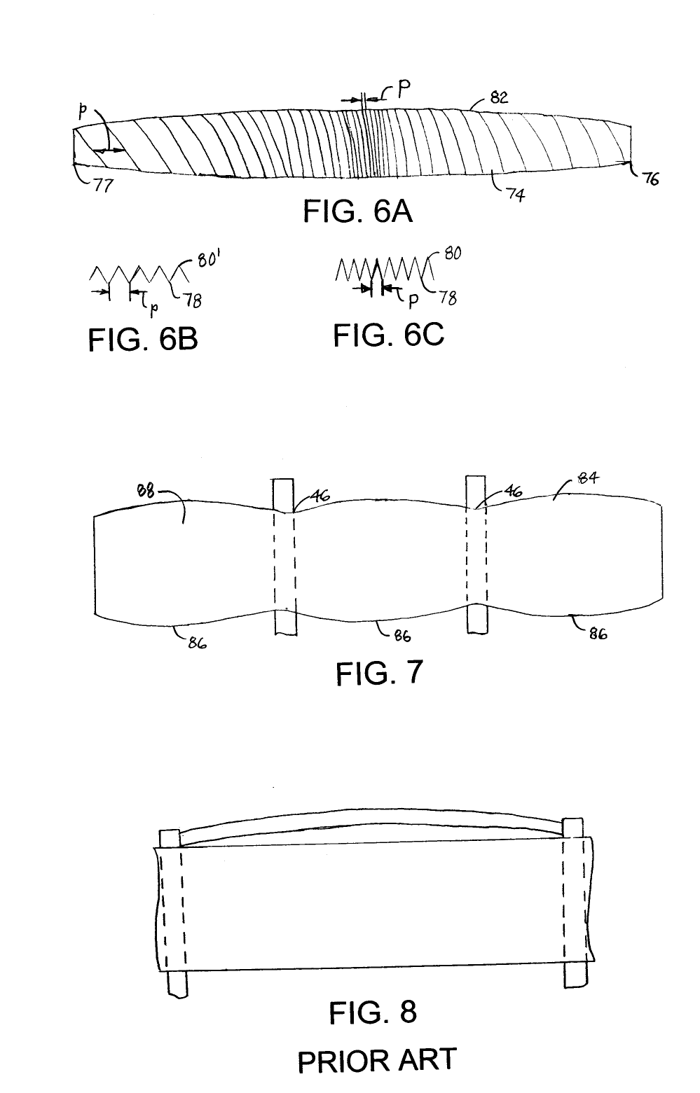

The crowned insert roller section 64 is made of a solid, hammer-forged steel rod or, as shown in FIG. 5, a hollow steel tube 70 swaged in a die to form a crowned outer surface 72. As another alternative, a solid rod or a hollow tube may be knurled as shown in the insert roller section 74 of FIGS. 6A-6C. In this example, the knurling pattern has thread-like grooves cut into the outer surface of a circular rod. The grooves may run in one direction or in opposite directions to form a cross-hatched or diamond pattern on the periphery of the rod. The pitch of the knurled grooves varies monotonically from a maximum pitch p at the ends 76, 77 of the rod to a minimum pitch P midway between the ends. The more closely spaced grooves 78 formed by the knurling displace rod material farther outward to form higher ridges 80 in the short-pitch region than the ridges 80′ formed in the longer-pitch region of the rod at its ends. Thus, the envelope 82 of the outer surface of an insert roller section 74 knurled this way forms the crowned profile shown in FIG. 6A.

An insert roller, whether made of a single roller or a series of end-to-end roller sections, is crowned between the positions of consecutive holddowns. An insert roller section held down only at its opposite ends would have a single crown along its length. An insert roller or an insert roller section having holddowns at intermediate positions along its lengths would have multiple crowns. Similarly, the powered rollers 84, i.e., the lower rollers and the channel-forming rollers, could be multi-crowned with crowns 86 formed along their lengths at multiple maximum-diameter positions located between, such as midway between, the holddown positions 46 of the insert rollers. The crowned outer surface 88 of the powered lower and the channel-forming rollers could be formed by a lathe, for example.

Thus, the peeling apparatus described uses crowned rollers that compensate for the natural tendency of small-diameter insert rollers to deflect between holddown positions to provide uniform contact pressure between the insert rollers and the powered rollers in the peeling channels. The insert rollers, the lower power roller, or the elevated channel-forming rollers in each peeling channel may be crowned for more effective peeling with less damage to the peeled product.

Although the invention has been described in detail with reference to shrimp-peeling apparatus, it applies as well to other kinds of roller-type peeling apparatus. So, the scope of the invention is not meant to be limited to the details of the exemplary versions used in the description.

What is claimed is:

1. Peeling apparatus comprising:
first and second rotating powered rollers separated by a gap extending along the length of the rollers;
a smaller-diameter insert roller held in counterrotating frictional contact with the first and second powered rollers by forces applied at spaced apart holddown positions along the length of the insert roller;
wherein the insert roller, the first roller, or the second roller is crowned with a maximum diameter between the holddown positions.

2. Peeling apparatus as in claim 1 wherein the diameter of the first powered roller varies along its length from a minimum diameter at the holddown positions to a maximum diameter midway between the holddown positions.

3. Peeling apparatus as in claim 1 wherein the diameter of the second powered roller varies along its length from a minimum diameter at the holddown positions to a maximum diameter midway between the holddown positions.

4. Peeling apparatus as in claim 1 wherein the insert roller has a diameter at each end that is less than the diameter in the middle.

5. Peeling apparatus as in claim 1 wherein the insert roller comprises a series of insert roller sections arranged end to end and the insert roller sections have a diameter at each end that is less than the diameter in the middle of each insert roller section.

6. Peeling apparatus as in claim 5 wherein each insert roller section is crowned.

7. Peeling apparatus as in claim 6 wherein each insert roller section has a crown profile that is selected to provide uniform contact pressure with the first and second powered rollers.

8. Peeling apparatus as in claim 5 wherein each insert roller section includes knurled ridges on its periphery, wherein the pitch of the ridges is greatest and the elevation of the ridges is least at the ends of the insert roller section.

9. Peeling apparatus as in claim 5 wherein each insert roller section is formed by hammer forging, swaging, or knurling.

10. Peeling apparatus as in claim 5 wherein each insert roller section is formed from a hollow tube.

11. Peeling apparatus as in claim 5 wherein each insert roller section is formed from a solid rod.

12. Peeling apparatus comprising:
first and second rotating powered rollers separated by a gap extending along the length of the rollers;
a smaller-diameter insert roller including one or more insert roller sections disposed in the gap in counterrotating frictional contact with the first and second powered rollers;
holddowns disposed at the ends of the one or more insert roller sections and extending through the gap to hold the insert roller in contact with the first and second powered rollers;
wherein the insert roller, the first roller, or the second roller is crowned with a maximum diameter between the ends of the one or more insert roller sections.

13. Peeling apparatus as in claim 12 wherein at least one of the first powered roller and the second powered roller includes multiple crowns along its length.

14. Peeling apparatus as in claim 12 wherein each insert roller section is crowned with a single crown along its length.

15. Peeling apparatus comprising:
an array of reciprocating lower rollers spaced apart laterally across the width of the peeling apparatus;
an array of reciprocating channel-forming rollers flanking and elevated slightly above the array of lower rollers across narrow gaps between the power rollers and the flanking channel-forming rollers;
wherein each lower roller forms the base of a peeling channel between laterally consecutive channel-forming rollers;
a pair of insert rollers disposed in each channel, each insert roller contacting the lower roller and one of the channel-forming rollers along the gap;
holddowns applying a force at spaced apart positions along the length of the insert rollers directed toward the gap to hold the insert rollers in counterrotating frictional contact with the lower roller and the associated one of the channel-forming rollers;
wherein the insert rollers, the lower rollers, or the channel-forming rollers are crowned with a maximum diameter midway between the positions of the holddowns.

16. Peeling apparatus as in claim 15 wherein each of the insert rollers includes a series of insert roller sections arranged end to end.

17. An insert roller section held down in the peeling nip formed by a pair of closely spaced, larger-diameter rotating powered peeler rollers in the peeling section of a roller-type peeling apparatus, comprising a metal roller having a crowned outer surface with a single crown along its length.

18. An insert roller section as in claim 17 wherein the outer surface of the insert roller section is knurled with ridges having a minimum pitch at the crown.

19. A powered lower or channel-forming roller for frictionally counterrotating a smaller-diameter insert roller in the peeling section of a roller-type peeling apparatus, comprising a roller having a crowned outer surface with at least one crown along its length.
